(19) United States
(12) Patent Application Publication
(10) Pub. No.: US 2003/0098283 A1
(43) Pub. Date: May 29, 2003

(54) Aquaculture water for marine fauna and flora and production method and system of the same

(76) Inventors: Masahiko Katayose, Aichi-ken (JP); Carlos E. Riquelme Salamanca, Antofagasta (CL)

Correspondence Address: David T. Nikaido, RADER, FISHMAN & GRAUER, PLLC, Suite 501, 1233 20th Street, NW, Washington, DC, 20036, US

(21) Appl. No.: 10/289,353

(22) Filed: Nov. 7, 2002

(30) Foreign Application Priority Data
Nov. 8, 2001 (JP) 2001-343538

(51) Int. Cl. C02F 1/48

(52) U.S. Cl. 210/748

(57) ABSTRACT

Production of aquaculture water for marine fauna and flora, prepared by seawater disinfected by electrolysis in an electrolytic treatment system and neutralized with a neutralization agent to eliminate deleterious effects to growth of microalgae.

### BACKGROUND OF THE INVENTION

1. Field of the Invention

The present invention relates to aquaculture water for marine fauna and flora and a production method and system of the same.

2. Description of the Prior Art

In intensive hatcheries of marine fauna and flora, it is most important to provide aquatic environments suitable for aquaculture of marine fauna and flora. Since the aquatic environments are greatly influenced by the quality of water for aquaculture, it is extremely important to purify and disinfect the water for aquaculture of marine fauna and flora.

For disinfection of culture water of aquatic animals and plants, there have been proposed treatments with ultraviolet light irradiation, heat, filtration, and addition of various kinds of sanitizer or germicide into culture water. However, each of these treatments is expensive in an aspect of aquaculture of marine organisms, and the aquaculture water treated by these treatments does not provide aquatic environments desirable for marine organisms. Particularly, the addition of sanitizer or germicide causes toxic residues for the marine organisms cultured in the treated water.

Recently, it is noticed that disinfection effects of electrolytic-treated seawater is useful for aquaculture of marine organisms. In Japanese Patent Laid-open Publications Nos. 8-33441 and 8-23821, there has been proposed an electrolytic disinfection method of seawater in which an electrolyzer is disposed in a water supply passage supplying seawater into a water tank to disinfect the seawater by electrolysis and to store the disinfected seawater in the water tank for aquaculture of marine fauna and flora.

Such a treatment method of disinfecting the seawater by electrolysis can be carried out at relatively low cost in comparison with the currently used methods. As the treatment method is carried out without using any sanitizer, germicide or the like, an expense rate for disinfection of the seawater is reduced. In this point of view, it is expected that the electrolytic treatment method of seawater becomes noticeably beneficial in aquaculture of marine organisms. However, the electrolytic-treated seawater is toxic for microalgae and causes harmful biocidal effect to growth of microalgae. Since the microalgae becomes important feeds for marine fauna and flora, the harmful biocidal effect to growth of microalgae deteriorates aquatic environments for culture of marine organisms.

### SUMMARY OF THE INVENTION

It is, therefore, a primary object of the present invention to disinfect aquaculture water for marine fauna and flora without causing any harmful biocidal effect to growth of microalgae.

According to the present invention, the object is attained by providing aquaculture water for marine fauna and flora which is prepared by diluted aqueous solution of inorganic salt disinfected by electrolysis in an electrolytic water treatment and neutralized with a neutralization agent to eliminate deleterious effects to growth of microalgae.

In a practical embodiment of the present invention, the aquaculture water for marine fauna and flora is prepared by seawater treated by electrolysis in the electrolytic treatment system, and free chlorine in the electrolytic-treated seawater is neutralized with sodium thiosulfate to neutralize germicidal effect of the aquaculture water.

According to an aspect of the present invention, there is provided a production method of aquaculture water for marine fauna and flora, comprising the steps of supplying purified seawater into an electrolyzer to disinfect the seawater by electrolysis in the electrolyzer, and neutralizing germicidal effect of the disinfected seawater with a neutralization agent.

According to another aspect of the present invention, there is provided a production system of aquaculture water for marine fauna and flora, comprising a seawater supply conduit for supplying seawater into a water tank, an electrolyzer disposed in the seawater supply conduit for electrolyzing the seawater supplied therethrough into the water tank, and a neutralization tank disposed in the seawater supply conduit at a downstream of the electrolyzer and added with a neutralization agent to neutralize germicidal effect of the electrolyzed seawater.

According to an aspect of the present invention, there is provided an electrolytic treatment system of aquaculture water for marine fauna and flora used in a hatchery, which comprises a seawater supply conduit for supplying seawater into the hatchery, an electrolyzer disposed in the seawater supplying conduit for electrolyzing the seawater supplied therethrough into the hatchery, a neutralization tank disposed in the seawater supply conduit at a downstream of the electrolyzer to store electrolytic-treated seawater supplied from the electrolyzer and added with a neutralization agent to neutralize free chlorine in the electrolytic-treated seawater thereby to eliminate harmful biocidal effect to growth of microalgae.

### BRIEF DESCRIPTION OF THE DRAWINGS

In the drawings,

FIG. 1 is a schematic illustration of an electrolytic treatment system for production of aquaculture seawater in accordance with the present invention;

FIG. 2 is a graph showing an effective chlorine concentration in relation to a current intensity for electrolysis of seawater in an electrolyzer with a non-membrane electrolytic cell;

FIG. 3 is a graph showing a concentration of pathogenic bacteria cultured in TSA medium of electrolytic aquaculture seawater treated by non-membrane electrolysis at different current intensities;

FIG. 4 is a graph showing a concentration of the pathogenic bacteria in aquaculture seawater prepared by non-membrane electrolytic treatment at a current intensity of 1.3 A in relation to a concentration of pathogenic bacteria cultured in TSA 2 medium of untreated seawater and a concentration of pathogenic bacteria in TCBS medium;

FIG. 5 is a graph showing growth of microalgae in seawater treated at different electrolytic intensities and then neutralized with sodium thiosulfate; and

FIG. 6 is a graph showing growth rates of the microalgae in seawater treated by electrolysis at 4.0 A and then neutralized with sodium thiosulfate and of the micoalgae in autoclaved seawater.

### DESCRIPTION OF THE PREFERRED EMBODIMENTS

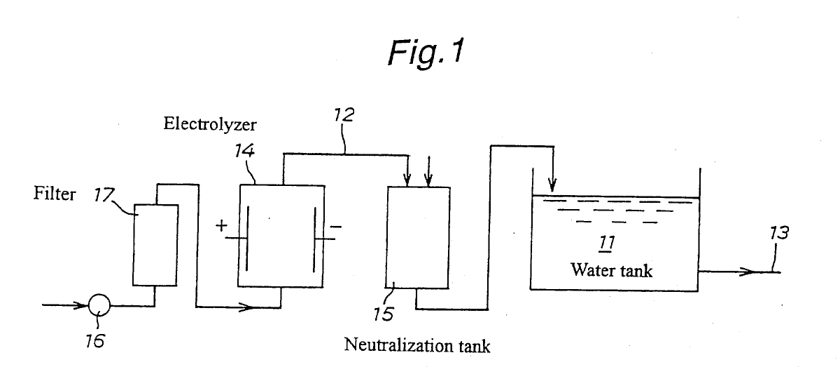

Illustrated in FIG. 1 is an electrolytic treatment system of aquaculture seawater in accordance with the present invention. The treatment system includes a water tank 11 provided to store seawater for aquaculture of marine fauna and flora, a seawater supply conduit 12 for supplying seawater into the water tank 11, a discharge conduit 13 for discharging the seawater from the water tank 11, an electrolyzer 14 with a non-membrane electrolytic cell disposed in the seawater supply conduit 12, a neutralization tank 15 disposed in the seawater supply conduit 12 at a downstream of the electrolyzer 14 to be added with a neutralization agent of germicidal effect of electrolyzed water produced in the electrolyzer 14, and a fluid pump 16 connected to the electrolyzer 14 through a filter 17.

In the treatment system, seawater pumped up by operation of the fluid pump16 is purified by the filter 17 and supplied into the electrolyzer 14. The seawater is partly electrolyzed by electrolysis in the electrolyzer 14 and is disinfected by electrolyzed water. The disinfected seawater is supplied into the neutralization tank 15 placed at the upstream of the water tank 11 and is added with an amount of neutralization agent to neutralize germicidal residues in the disinfected seawater. Thus, the neutralized seawater is supplied into the water tank 11 in a disinfected condition without germicidal residues and stored in the water tank 11 for aquaculture of marine fauna and flora. Accordingly, the electrolytic treatment system can be utilized as a hatchery aquiculture system.

In the electrolytic water treatment system, an electrolyzer of the JIX-40TA type made by Hoshizaki Electric Co. Ltd. was adapted as the non-membrane type electrolyzer 14. In the electrolyzer 14, an intensity of electrolytic current can be adjusted by control of D.C voltage applied to the electrodes in electrolyzer 14. For example, in the case that the concentration of salt content in seawater is 3.4-3.5% by weight, the intensity of electrolytic current is adjusted to 0.3 A-2.0 A so that the effective chlorine concentration is adjusted to 0.39 mg Cl/L-6.5 mg Cl/L and that the pH of electrolyzed water is adjusted to 8.24-8.27.

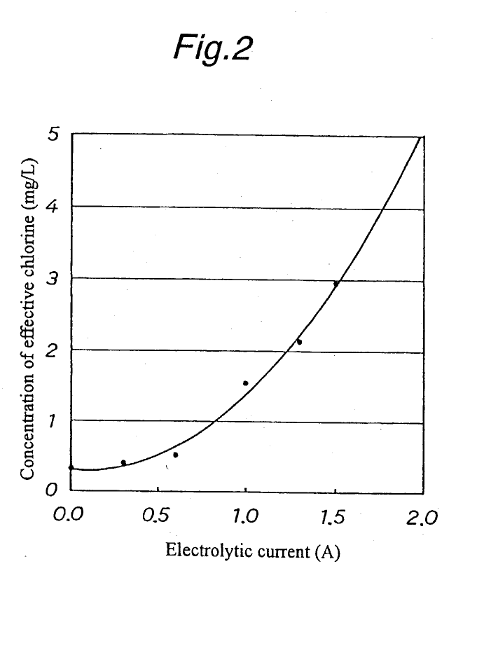

In FIG. 2, there is shown an effective chlorine concentration of electrolyzed water in relation to an intensity of electrolytic current in the electrolyzer 14. As the effective chlorine of electrolyzed water is interrelated to germicidal effect against bacteria pathogens in seawater, the intensity of electrolytic current itself is interrelated to the germicidal effect. Accordingly, the intensity of electrolytic current can be evaluated as a standard of the germicidal effect against bacteria pathogens in seawater.

The seawater disinfected by the electrolyzed water as described above was neutralized in the neutralization tank 15 to eliminate harmful biocidal effect to growth of microalgae so as to provide aquatic environments desirable for culture of the marine organisms. As the germicidal effect against bacteria pathogens is caused by effective chlorine, sodium thiosulfate was used as a neutralization agent suitable for neutralizing free chlorine in the seawater.

### EXAMPLE

As to the aquaculture seawater treated by the electrolytic treatment system shown in FIG. 1, experiments for evaluation of a disinfected condition (electrolytic disinfection) and aquatic environments were carried out. As a comparative example, experiments for evaluation of a disinfected condition and aquatic environments were carried out with respect to untreated seawater and UV irradiation-treated water for culture of marine organisms. In the experiments for evaluation of the electrolytic disinfection, the filtrated seawater was experimentally dowsed with the known scallop pathogen Vibrio anguillarum and adapted as a sample of culture seawater in the evaluation. In the experiments for evaluation of aquatic environments, a growth condition of the microalgae (food), Isochrysis galbana of scallop was evaluated.

1. Bacteriological evaluations of electrolytic disinfection:

In the electrolytic treatment system shown in FIG. 1, the filtrated seawater was supplied into the non-membrane type electrolyzer at a constant flow rate of 4 l/min, while the electrodes in the electrolyzer were applied with different DC voltages of 1.9 V-2.1 V to effect electrolysis of the supplied seawater at different current intensities of 0.1 A-2.0 A. On the other hand, the UV irradiation-treated water was prepared by passing the seawater through a UV irradiation system (Rainbow Lifegard, USA; 40W) at a constant flow rate of 4 l/min.

The samples of treated seawater and untreated seawater were seeded onto tryptone soy agar supplemented with 2% NaCl (TSA, Oxoid) using standard culture methodology to enumerate culturable heterotrophic bacteria, which were recoded as colony forming units (CFU). Direct counts of total bacteria (DTC) and direct counts of viable bacteria (DVC) were carried out on: (i) seawater subjected to electrolytic treatments at 0.3 A, 1.3 A and 2.0 A; (ii) UV irradiation-treated seawater, and (iii) untreated control seawater. DTC was carried out using the DNA-specific fluorochrome DAPI which is excited under UV light, and DVC was carried out using a modification of the 6CFDA staining methods described by Yamaguchi et al. (1997).

Water samples (0.8 ml) were mixed with 0.4 ml CFDA buffer (0.3 M phosphate buffer pH 8.5; 1.5 mM EDTA). Subsequently, a stock solution of 6CFDA (Sigima; 10 mg ml in acetone) and DAPI (Sigma; 10 μg ml⁻¹) were applied to the samples to give a final concentration of 150 μg ml⁻¹ (6CFDA) and 1 μg ml⁻¹ (DAPI). The samples were incubated for 30 min at room temperature in the dark, and then the cells were filtered off onto black polycarbonate filters (Poretics Products; 0.2 μm porosity). The filters were placed on microscope slides and the stained bacteria were enumerated under UV light (DAPI) and blue light (6CFDA) excitation by epifluorescence microscopy. Results of the observation are shown in the following table 1.

TABLE 1

| | Total cells | Active cells | Percentage of |
|---|---|---|---|
| Treatments | (cells ml) | (Cells ml) | active bacteria (%) |
| Control | 3.96 × 10⁵ | 3.12 × 10⁴ | 7.88 |
| UV | 2.83 × 10⁵ | 3.52 × 10⁴ | 12.46 |
| 0.3 A | 2.16 × 10⁵ | ND | ND |
| 1.3 A | 1.90 × 10³ | ND | ND |
| 2.0 A | 3.26 × 10² | ND | ND |

In the above observations, any physiological active bacteria was not detected at all in the seawater treated by electrolysis at the current intensities of 0.3 A, 1.3 A and 2.0 A. In contrast with the treated seawater, active bacteria of about 7%-13% in total cells was detected in the UV irradiated seawater and untreated seawater. Particularly, it has been found that dissolution of bacteria initiates in the seawater treated by electrolysis at the current intensity of 1.3 A, significantly in the seawater treated by electrolysis at the current intensity of 2.0 A.

2. Effect of electrolysis on seawater dosed with the pathogen Vibrio anguillarum

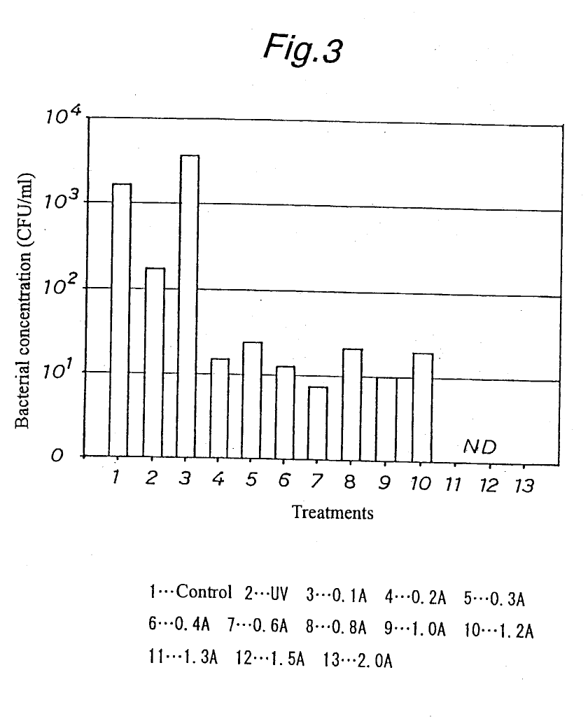

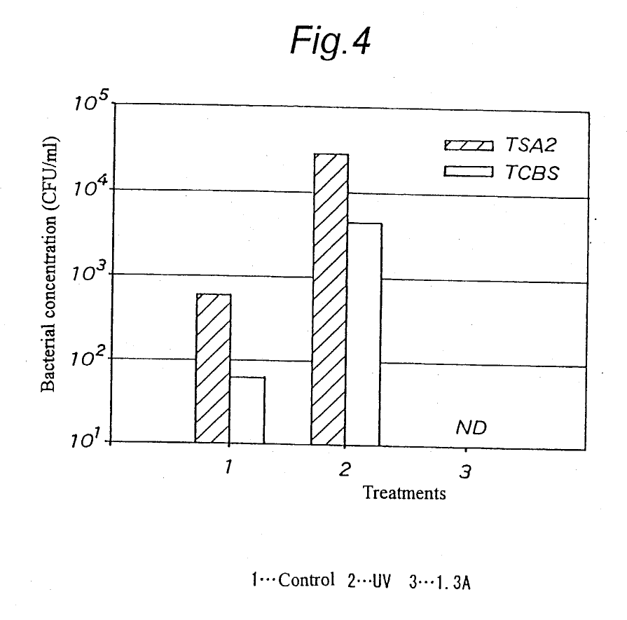

This experiment was carried out using a pure culture of the scallop pathogen Vibrio anguillarum. Cells obtained from an overnight culture on TSA2 medium and TCBS medium were inoculated into polyethylene bags. Immediately after inoculation, the seawater containing the pathogen was treated by electrolysis in the electrolyzer at different current intensities in the same condition as in the above evaluation. For comparative evaluation, experiments for evaluation of the UV irradiation-treated seawater and untreated control water dosed with the pathogen were carried out. Counts of colony forming units (CFU) in the water samples were made by a simple crystal-violet staining method. Results of the experiments are shown in FIGS. 3 and 4.

Illustrated in a graph of FIG. 3 are disinfected conditions of bacteria cultured on TSA2 medium. Significant disinfection of bacteria was confirmed in the seawater treated by electrolysis. Particularly, any active bacteria was not detected at all in the seawater treated by electrolysis at a current intensity of more than 1.3 A. On the contrary, it has been found that inactivation of bacteria in UV irradiation-treated seawater was lower than that of bacteria in the culture seawater treated by electrolysis at a current intensity of more than 0.2 A.

Illustrated in a graph of FIG. 4 is a disinfected condition of bacteria cultured in the TSA2 medium in comparison with that of bacteria in the TCBS medium. In FIG. 4, a graph A represents pathogen-dosed seawater, prior to electrolytic treatment, and a graph B represents pathogen-dosed seawater immediately after electrolytic treatment. In this case, it has been confirmed that the bacteria both in TSA2 medium and TCBS medium was completely inactivated.

3. Experiments for evaluation of culture environments:

Water samples submitted to electrolysis at current intensities of 1.0 A, 1.5 A, 2.0 A, 2.5 A, 3.0 A and 4.0 A were collected in 250-ml glass bottles. Free chlorine measured in these waters was neutralized by the addition of sodium thiosulfate at a ratio of 5 mol thiosulfate for every 8 mol NaOCl in the water. Thereafter, the seawater was filtered through 0.2-μm cellulose nitrate filters, and aliquots of 100 ml were distributed into sterile 250-ml Eflenmeyeer flasks.

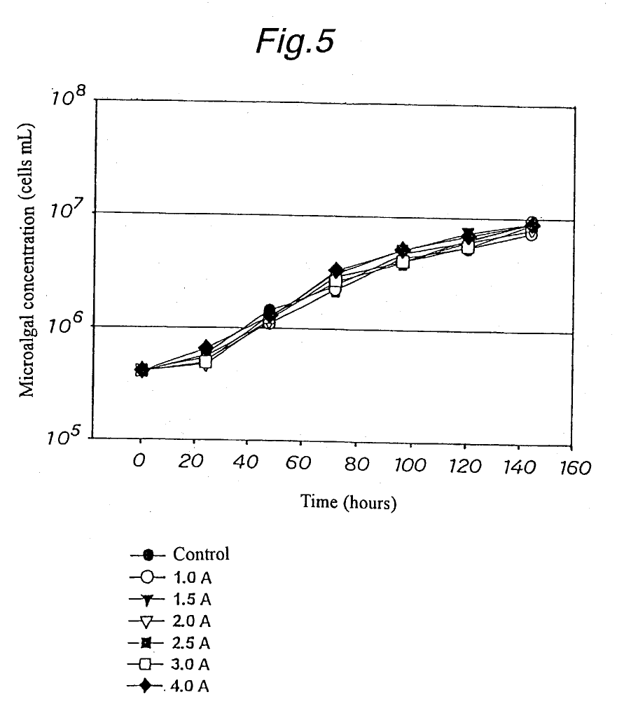

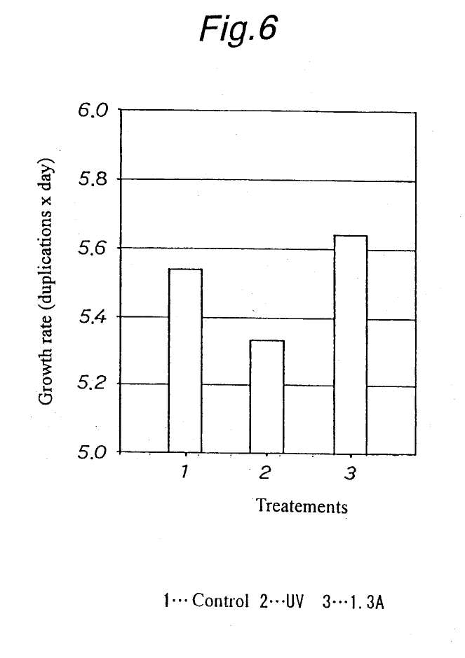

The flasks were enriched with sterile Fritz f/2 algae food (Aquaculture Massachusetts, USA) and inoculated with axenic log-phase cultures of the microalgae Isochrysis galbana at 4×10⁵ cells ml. Control cultures were carried out in autoclaved seawater containing the same nutrients as in the treatments. Algal densities were determined for experimental and control flasks by quantitative cell counting in a Neubauer chamber every 24 hours post-inoculation for a period of 6 days. Microalgal growth rates were calculated by the Guillard method. Results of determination of microalgal growth rates among treatments were compared by analysis of variance (P=0.05) using Statgraphics software (version 2.1 for Windows, Statgraphics). Also, comparative factors which might demonstrate significant differences between treated and untreated seawaters were evaluated using a multiple range comparison least significant differences (LSD) test. Results of the evaluation are shown in FIGS. 5 and 6.

Illustrated in a graph of FIG. 5 is growth conditions of the microalgae in the seawater treated at different electrolytic intensities and then neutralized with sodium thiosulfate. In the growth conditions, it has been confirmed that the seawater does not affect any harmful biocidal effect to growth of microalgae. In addition, any significant difference in growth of the microalgae between the treated seawater and the untreated control water was not found. Illustrated in a graph of FIG. 6 are growth rates of microalgae in the seawater treated by electrolysis at 4.0 A and neutralized with sodium thiosulfate in comparison with those in the UV irradiation-treated seawater. In this comparison, it has been confirmed that the growth rate of microalgae in the electrolytic-treated seawater is higher than that of microalgae in the untreated control water and irradiation-treated seawater.

What is claimed is:

1. Aquaculture water for marine fauna and flora, prepared by diluted aqueous solution of inorganic salt disinfected by electrolysis in an electrolytic treatment system and neutralized with a neutralization agent to eliminate deleterious effects to growth of microalgae.

2. Aquaculture water for marine fauna and flora as claimed in claim 1, wherein the aquaculture water is prepared by seawater treated by electrolysis in the electrolytic treatment system.

3. Aquaculture water for marine fauna and flora as claimed in claim 1, wherein the aquaculture water is prepared by seawater treated by electrolysis at a current intensity of more than 1.3 A in the electrolytic treatment system.

4. Aquaculture water for marine fauna and flora as claimed in claim 1, wherein free chlorine in the electrolytic-treated water is neutralized with the neutralization agent to neutralize germicidal effect of the aquaculture water.

5. Aquaculture water for marine fauna and flora as claimed in claim 1, wherein thiosulfate is adapted as the neutralization agent to neutralize the germicidal effect of the electrolytic-treated water.

6. A production method of aquaculture water for marine fauna and flora, comprising the steps of:
supplying purified seawater into an electrolyzer to disinfect the seawater by electrolysis in the electrolyzer; and
neutralizing germicidal effect of the disinfected seawater with a neutralization agent.

7. A production method of aquaculture water for marine fauna and flora, comprising the steps of:
supplying purified seawater into an electrolyzer to disinfect the seawater by electrolysis at a current intensity of more than 1.3 A in the electrolyzer; and
neutralizing germicidal effect of the disinfected seawater with a neutralization agent.

8. A production system of aquaculture water for marine fauna and flora, comprising:
a seawater supply conduit for supplying seawater into a water tank;
an electrolyzer disposed in the seawater supply conduit for electrolyzing the seawater supplied therethrough into the water tank; and
a neutralization tank disposed in the seawater supply conduit at a downstream of the electrolyzer and added with a neutralization agent to neutralize germicidal effect of the electrolyzed seawater.

9. A production system of aquaculture water for marine fauna and flora as claimed in claim 8, wherein the seawater is electrolyzed at a current intensity of more than 1.3 A in the electrolyzer.

10. An electrolytic treatment system of aquaculture water for marine fauna and flora used in a hatchery, comprising:
a seawater supply conduit for supplying seawater into the hatchery;
an electrolyzer disposed in the seawater supplying conduit for electrolyzing the seawater supplied therethrough into the hatchery;
a neutralization tank disposed in the seawater supply conduit at a downstream of the electrolyzer to store electrolytic-treated seawater supplied from the electrolyzer and added with a neutralization agent to neutralize free chlorine in the electrolytic-treated seawater thereby to eliminate harmful biocidal effect to growth of microalgae.

11. An electrolytic treatment system as claimed in claim 10, wherein the seawater is electrolyzed at a current intensity of more than 1.3 A in the electrolyzer.

12. An electrolytic treatment system as claimed in claim 10, wherein thiosulfate is used as the neutralization agent to neutralize germicidal effect of the electrolytic-treated seawater.
